(19) United States
(12) Patent Application Publication
(10) Pub. No.: US 2007/0062656 A1
(43) Pub. Date: Mar. 22, 2007

(54) Linerboard With Enhanced CD Strength For Making Boxboard

(75) Inventors: Frank C. Murray, Marietta, GA (US); Steven L. Edwards, Fremont, WI (US); Daniel W. Sumnicht, Green Bay, WI (US)

Correspondence Address: PATENT GROUP GA030-43;GEORGIA-PACIFIC LLC, 133 PEACHTREE STREET, N.E., ATLANTA, GA, 30303-1847, US

(73) Assignee: FORT JAMES CORPORATION, Atlanta, GA (US)

(21) Appl. No.: 11/531,422

(22) Filed: Sep. 13, 2006

Related U.S. Application Data
(60) Provisional application No. 60/718,909, filed on Sep. 20, 2005.

(51) Int. Cl. B31F 1/12; B32B 29/00

(52) U.S. Cl. 162/111; 162/123; 428/153; 428/537.5

(57) ABSTRACT

A method of making linerboard with elevated CD strength includes: a) compactively dewatering a papermaking furnish to form a nascent web having an apparently random distribution of papermaking fibers; b) applying the dewatered web having apparently random fiber distribution to a translating transfer surface moving at a first speed; c) fabric-creping the web from the transfer surface at a consistency of from about 15 to about 75 percent utilizing a patterned creping fabric. The creping step occurs under pressure in a fabric-creping nip defined between the transfer surface and the creping fabric, wherein the fabric is traveling at second speed slower than the speed of the transfer surface and the fabric pattern, nip parameters, velocity, delta and web consistency are selected such that the web is creped from the transfer surface and distributed on the creping fabric. The fabric-creped web has an elevated CD strength as compared with the web prior to fabric-creping. The process further includes: d) wet-pressing the web after fabric-creping; and e) drying the web.

### CLAIM FOR PRIORITY

This non-provisional patent application is based upon United States Provisional Application Ser. No. 60/718,909 of the same title, filed Sep. 20, 2005, the priority of which is hereby claimed and the disclosure of which is hereby incorporated herein by reference.

### TECHNICAL FIELD

The present invention relates generally to linerboard for making corrugated combined board which is referred to as boxboard. The linerboard of the present invention has reoriented fiber bias in the cross machine direction (CD) for providing additional CD strength to linerboard at a given basis weight. Boxboard and containers incorporating the linerboard of the present invention exhibit enhanced stiffness and crush strength or may be made with less fiber at equivalent strength to heavier board.

### BACKGROUND

Boxboard or corrugated combined board, as it is sometimes referred to, is used to make containers for many products, including bulky items such as appliances and furniture. Referring to FIG. 1, a typical construction includes an outer linerboard layer 10, a corrugated layer 12 and an inner linerboard layer 14. The various layers are glued or otherwise adhered to each other to make the combined boxboard structure 16. Generally, the various layers are formed on separate papermachines and combined later with the orientation shown, wherein the machine-direction (MD) of all three layers are aligned and the flutes of the corrugated layer are perpendicular to the MD.

Some processes have been proposed to prepare the various layers on integrated papermachines in order to reduce waste and more efficiently produce combined board.

There is described, for example, in U.S. Pat. No. 4,285,764 to Salvai a method and apparatus for making multi-ply corrugated container board on a single papermachine. In the '764 patent the corrugated container board is made by way of forming separate webs from aqueous slurries of fibers and dewatering each of the slurries sufficiently to form a web ply capable of being handled in a papermachine as an integral web. All the webs are formed on the single paper making machine, but separately. The first web ply is laid on a traveling forming wire such as a Fordrinier Wire and each subsequent web ply is formed in close proximity to the traveling forming wire and brought into bonding engagement seriatim with the top surface of the previously formed web carried on the traveling forming wire. There is disclosed in U.S. Pat. No. 6,569,287 to Hoffman another integrated process for preparing multi-ply, corrugated paperboard. In the Hoffman '287 patent each boxboard component is prepared with separate forming, pressing and drying sections of the papermachine for each layer.

Containers formed from boxboard typically align the MD of the boxboard around the periphery of a container such that the flutes are vertically oriented as are the CD's of each layer. This arrangement, while convenient for manufacturing the containers, does not optimize crush strength because conventional linerboard is much stronger in the MD than in the CD. Conventional linerboard may have MD/CD tensile ratios of 3-5, for example.

One way of increasing crush strength of boxboard containers is to simply use heavier linerboard. This approach uses more fiber and is accordingly expensive.

Another approach for increasing the crush strength of boxboard containers which has been suggested is to change the container manufacturing process to orient the MD of linerboard in a vertical direction; that is, in the same direction as the flutes of the corrugated layer. This approach requires substantial capital investment since existing container manufacturing assets cannot be used.

In accordance with the present invention, there is provided linerboard with enhanced CD strength that allows use of existing container manufacturing assets to make stronger containers, or to make containers of comparable strength using less fiber.

### SUMMARY OF INVENTION

In accordance with the present invention, CD strength is conveniently provided to paperboard by elevating CD strength bias to the board during its manufacture. There is provided in accordance with one aspect of the present invention a method of making linerboard with elevated CD strength including the steps of: a) compactively dewatering a paper making furnish to form a nascent web having apparently random distribution of paper making fibers; b) applying the dewatered web having apparently random fiber distribution to a translating transfer surface moving at a first speed; c) fabric-creping the web from the transfer surface at a consistency of from about 15 to about 75 percent. The creping step is carried out utilizing a patterned creping fabric and it occurs under pressure in a fabric-creping nip defined between the transfer surface and the creping fabric. The creping fabric is traveling at a second speed slower than the speed of the transfer surface and the fabric pattern, nip parameters, velocity delta and web consistency are selected such that the web is creped from the transfer surface and distributed on the creping fabric to form a fabric-creped web with a relative CD strength bias. After fabric-creping, the web is wet-pressed in order to densify it before being dried. In order to get sufficient density, it may be required under some circumstances to re-wet the web after fabric-creping and prior to wet-pressing the fabric-creped web. The consistency of the web upon fabric-creping is perhaps more preferably between about 20 percent and 60 percent, with from about 30 percent to about 50 percent being believed suitable.

The invention may likewise be practiced on a multilayer linerboard machine by creping one or more of the plies employed to make the linerboard.

The process is operated with different amounts of fabric crepe; depending upon the amount of foreshortening desirable for a given product. A fabric crepe between about 10 and about 100 percent is suitable in many instances; typically a fabric crepe of at least about 40 percent or so provides significant property modification. Fabric crepes of at least about 60 or 80 percent can provide even more redistribution of fiber. In cases where it is desired to maintain MD stiffness while moderately increasing CD stiffness, fabric crepe down to about 5% may be used.

Optionally, the web is calendered after wet-pressing.

Preferably, the fabric-creped web is provided with a plurality of elongate fiber-enriched regions extending in the CD inter-connected by lower basis weight regions.

The creping fabric has a texture volume of anywhere from about 25 percent to about 100 percent with respect to the web volume. From about 35 to about 75 percent with respect to the web volume is believed to be an appropriate texture volume for the creping fabric. So also, the creping fabric preferably has texture cells with a CD/MD aspect ratio of at least about 5. A CD/MD aspect ratio for the texture cells of at least about 10, at least about 25, at least about 50 or at least about 100 or more, is advantageous. Without intending to be bound by any theory, it is believed that CD extending fiber-enriched regions provide additional crush strength for the linerboard, much like additional corrugation. The fiber in the papermaking furnish for making the inventive linerboard preferably consists essentially of Southern softwood fiber. By the terminology, “consists essentially of” it is meant that the papermaking fiber in the furnish is mostly (at least about 75 percent) Southern softwood fiber. This terminology does not exclude other additives such as binders and the like. Perhaps most preferably, all of the fiber in the linerboard is Southern softwood fiber. The linerboard of the invention typically has a basis weight of between about 7.5 to about 100 lbs/1000 sq. ft. ream. From about 10 to about 60 lbs/1000 sq. ft. ream is typical and from about 15 to about 35 lbs/1000 sq. ft. ream is preferred in many cases. While fabric-creping or otherwise introducing CD bias into the paper web is particularly suitable for the linerboard manufacture of the present invention, the CD strength of the fluted or corrugated layer also be improved by introducing CD bias to the fiber of the medium or fluted layer by way of creping or otherwise mechanically rearranging the fiber in that layer immediately prior to fluting, for example.

A typical method of making the fabric-creped linerboard of the invention includes preparing a cellulosic furnish and providing the paper making furnish to a forming fabric as a jet issuing from the headbox at a jet speed. The furnish is compactively dewatered to form a nascent web having an apparently random distribution of fiber and fabric-creped, wet-pressed, and dried as described above. The creping fabric and furnish are selected and the various processing parameters such as the jet and forming fabric speed and the drying, wet-pressing and fabric-creping conditions are controlled such that the linerboard has the desired properties. Suitably the linerboard has a MD/CD tensile ratio of about 2.5 or less. A MD/CD tensile ratio of about 2 or less or even 1 or less is preferred in many cases.

A CD stretch of the linerboard of the invention is typically less than about 5. Less than about 4 or less than about 3 is perhaps more preferred. As will be appreciated by one of skill in the art, the linerboard of the invention does not sorb much liquid. The linerboard typically has a void volume of less than about 2.5. A void volume of between about 1 and 2 is typical for the products of the invention.

Preferably, the process of the invention is carried out with a jet to wire velocity ratio of between about 0.7 and about 1.4. Between about 1 and about 1.3 is typical with from about 1.1 to about 1.25 being preferred depending upon the furnish and processing parameters.

Further aspects of the invention include linerboard and boxboard products with layers having the attributes noted above. These and other features of the invention will become apparent on the discussion which follows.

### BRIEF DESCRIPTION OF DRAWINGS

The invention is described in detail below with reference to the drawings wherein:

FIG. 1 is a schematic view showing a typical combined boxboard construction;

FIG. 2 is a schematic representation of a creping fabric useful in connection with the present invention;

FIG. 3 is a photomicrograph (10×) of an as-creped web showing elevated CD fiber bias and elongate, fiber-enriched regions extending in the CD;

FIG. 4 is a schematic diagram of a papermachine useful for making linerboard of the invention; and

FIGS. 5-11 are graphs illustrating the effect of jet/wire velocity ratio, fabric crepe and fabric selection on web properties.

### DETAILED DESCRIPTION

The invention is described in detail below; such discussion is for purposes of illustration only. Modifications to particular examples within the spirit and scope of the present invention, set forth in the appended claims, will be readily apparent to one of skill in the art.

Terminology used herein is given its ordinary meaning consistent with the exemplary definitions set forth immediately below.

Throughout this specification and claims, when we refer to a nascent web having an apparently random distribution of fiber orientation (or use like terminology), we are referring to the distribution of fiber orientation that results when known forming techniques are used for depositing a furnish on the forming fabric. When examined microscopically, the fibers give the appearance of being randomly oriented even though, depending on the jet to wire speed, there may be a significant bias toward machine direction orientation making the machine direction tensile strength of the web exceed the cross-direction tensile strength.

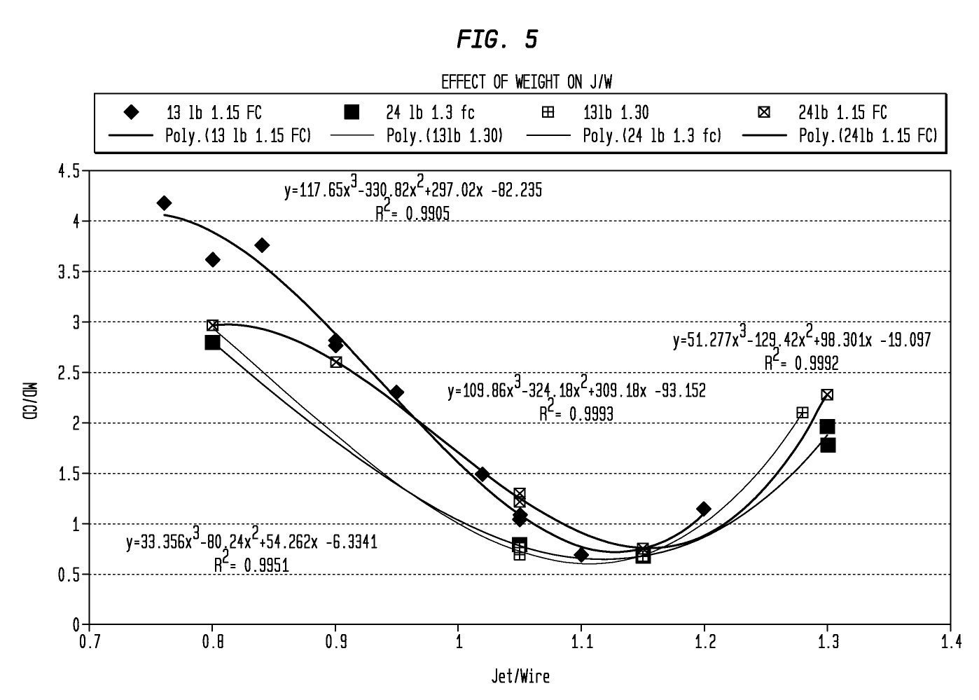

Unless otherwise specified, “basis weight”, BWT, bwt and so forth refers to the weight of a 1000 square foot ream of product; in FIGS. 5-11, basis weight refers to 3000 square foot ream basis weight. Consistency refers to percent solids of a nascent web, for example, calculated on a bone dry basis. “Air dry” means including residual moisture, by convention up to about 10 percent moisture for pulp and up to about 6% for paper. A nascent web having 50 percent water and 50 percent bone dry pulp has a consistency of 50 percent.

Relative CD strength bias and like terminology refers to increased relative CD tensile strength or reduced MD/CD tensile ratios of the linerboard of the invention as compared with conventional linerboard. Without intending to be bound by any theory, it is believed that fabric-creping while controlling creping parameters appropriately provides CD orientation bias to the fiber in the web and provides the increased CD strength. Relative CD strength bias is conveniently determined by comparing the MD/CD tensile ratio of a product of the invention with a linerboard web of like composition made by a conventional linerboard manufacturing process utilizing substantially the same raw materials. Alternatively, relative CD strength bias may be determined by comparing a product of the invention with like linerboard produced on the same equipment without substantial fabric-creping of the web.

The term “cellulosic”, “cellulosic sheet” and the like is meant to include any product incorporating papermaking fiber having cellulose as a major constituent. “Papermaking fibers” include virgin pulps or recycle (secondary) cellulosic fibers or fiber mixes comprising cellulosic fibers. Fibers suitable for making the webs of this invention include: nonwood fibers, such as cotton fibers or cotton derivatives, abaca, kenaf, sabai grass, flax, esparto grass, straw, jute hemp, bagasse, milkweed floss fibers, and pineapple leaf fibers; and wood fibers such as those obtained from deciduous and coniferous trees, including softwood fibers, such as northern and southern softwood kraft fibers; hardwood fibers, such as eucalyptus, maple, birch, aspen, or the like. Papermaking fibers can be liberated from their source material by any one of a number of chemical pulping processes familiar to one experienced in the art including sulfate, sulfite, polysulfide, soda pulping, etc. The pulp can be bleached if desired by chemical means including the use of chlorine, chlorine dioxide, oxygen, alkaline peroxide and so forth. The products of the present invention may comprise a blend of conventional fibers (whether derived from virgin pulp or recycle sources) and high coarseness lignin-rich tubular fibers, such as bleached chemical thermomechanical pulp (BCTMP). “Furnishes” and like terminology refers to aqueous compositions including papermaking fibers, optionally wet strength resins, debonders and the like for making paper products.

The present invention advantageously employs recycle containing furnishes with up to 100% recycle papermaking fibers.

Calipers and/or bulk reported herein may be 1, 4 or 8 sheet calipers. The sheets are stacked and the caliper measurement taken about the central portion of the stack. Preferably, the test samples are conditioned in an atmosphere of 23°±1.° C. (73.4°±1.8° F.) at 50% relative humidity for at least about 2 hours and then measured with a Thwing-Albert Model 89-II-JR or Progage Electronic Thickness Tester with 2-in (50.8-mm) diameter anvils, 539±10 grams dead weight load, and 0.231 in./sec descent rate. For finished product testing, each sheet of product to be tested must have the same number of plies as the product is sold. For testing in general, eight sheets are selected and stacked together. For napkin testing, napkins are enfolded prior to stacking. For base sheet testing off of winders, each sheet to be tested must have the same number of plies as produced off the winder. For base sheet testing off of the papermachine reel, single plies must be used. Sheets are stacked together aligned in the MD. On printed product, try to avoid taking measurements in these areas if at all possible. Bulk may also be expressed in units of volume/weight by dividing caliper by basis weight.

“Can drying” refers to drying a web by contacting a web with a dryer drum while not adhering the web to the dryer surface, typically while the web is also in contact with a fabric. In a single-tier system, only one side of the web contacts the drums, while in a conventional two-tier system, both sides of the web contact dryer surfaces.

As used herein, the term compactively dewatering the web or furnish refers to mechanical dewatering by wet-pressing on a dewatering felt, for example, in some embodiments by use of mechanical pressure applied continuously over the web surface as in a nip between a press roll and a press shoe wherein the web is in contact with a papermaking felt. The terminology “compactively dewatering” is used to distinguish processes wherein the initial dewatering of the web is carried out largely by thermal means as is the case, for example, in U.S. Pat. No. 4,529,480 to Trokhan and U.S. Pat. No. 5,607,551 to Farrington et al. noted above. Compactively dewatering a web thus refers, for example, to removing water from a nascent web having a consistency of less than 30 percent or so by application of pressure thereto and/or increasing the consistency of the web by about 15 percent or more by application of pressure thereto.

Creping fabric and like terminology refers to a fabric or belt which bears a pattern suitable for practicing the process of the present invention.

Fpm refers to feet per minute while consistency refers to the weight percent fiber of the web.

MD means machine direction and CD means cross-machine direction; thus, the CD is perpendicular to the MD, in the plane of the web.

Nip parameters include, without limitation, nip pressure, nip length, backing roll hardness, fabric approach angle, fabric takeaway angle, uniformity, and velocity delta between surfaces of the nip.

Nip length means the length over which the nip surfaces are in contact.

A translating transfer surface refers to the surface from which the web is creped into the creping fabric. The translating transfer surface may be the surface of a rotating drum as described hereafter, or may be the surface of a continuous smooth moving belt or another moving fabric which may have surface texture and so forth. The translating transfer surface needs to support the web and facilitate the high solids creping as will be appreciated from the discussion which follows.

Dry tensile strengths (MD, CD and GMT), stretch, ratios thereof, modulus, break modulus, stress and strain are measured with a standard Instron test device or other suitable elongation tensile tester which may be configured in various ways, typically using 3 or 1 inch wide strips of tissue or towel, conditioned in an atmosphere of 23°±1° C. (73.4°±1° F.) at 50% relative humidity for 2 hours. The tensile test is run at a crosshead speed of 2 in/min. Modulus is expressed in lbs/inch per inch of elongation unless otherwise indicated. GMT is the square root of the product of the MD and CD tensiles.

Tensile ratios are simply ratios of the values determined by way of the foregoing methods. Unless otherwise specified, a tensile property is a dry sheet property.

“Fabric crepe ratio” is an expression of the speed differential between the creping fabric and the forming wire and typically calculated as the ratio of the web speed immediately before fabric-creping and the web speed immediately following fabric-creping, the forming wire and transfer surface being typically, but not necessarily, operated at the same speed:
Fabric crepe ratio=transfer cylinder speed÷creping fabric speed

Fabric crepe can also be expressed as a percentage calculated as:
Fabric crepe, percent, =[Fabric crepe ratio−1]×100%

A web creped from a transfer cylinder with a surface speed of 750 fpm to a fabric with a velocity of 500 fpm has a fabric crepe ratio of 1.5 and a fabric crepe of 50%.

PLI or pli means pounds force per linear inch.

Pusey and Jones (P&J) hardness (indentation) is measured in accordance with ASTM D 531, and refers to the indentation number (standard specimen and conditions).

Velocity delta means a difference in linear speed.

The void volume and/or void volume ratio as referred to hereafter, are determined by saturating a sheet with a nonpolar POROFIL® liquid and measuring the amount of liquid absorbed. The volume of liquid absorbed is equivalent to the void volume within the sheet structure. The percent weight increase (PWI) is expressed as grams of liquid absorbed per gram of fiber in the sheet structure times 100, as noted hereinafter. More specifically, for each single-ply sheet sample to be tested, select 8 sheets and cut out a 1 inch by 1 inch square (1 inch in the machine direction and 1 inch in the cross-machine direction). For multi-ply product samples, each ply is measured as a separate entity. Multiple samples should be separated into individual single plies and 8 sheets from each ply position used for testing. To measure absorbency, weigh and record the dry weight of each test specimen to the nearest 0.0001 gram. Place the specimen in a dish containing POROFIL® liquid having a specific gravity of about 1.93 grams per cubic centimeter, available from Coulter Electronics Ltd., Northwell Drive, Luton, Beds, England; Part No. 9902458.) After 10 seconds, grasp the specimen at the very edge (1-2 Millimeters in) of one corner with tweezers and remove from the liquid. Hold the specimen with that comer uppermost and allow excess liquid to drip for 30 seconds. Lightly dab (less than ½ second contact) the lower corner of the specimen on #4 filter paper (Whatman Lt., Maidstone, England) in order to remove any excess of the last partial drop. Immediately weigh the specimen, within 10 seconds, recording the weight to the nearest 0.0001 gram. The PWI for each specimen, expressed as grams of POROFIL® liquid per gram of fiber, is calculated as follows:
PWI=[(W₂−W₁)/W₁]×100%
wherein

“W₁” is the dry weight of the specimen, in grams; and

“W₂” is the wet weight of the specimen, in grams.

The PWI for all eight individual specimens is determined as described above and the average of the eight specimens is the PWI for the sample.

The void volume ratio is calculated by dividing the PWI by 1.9 (density of fluid) to express the ratio as a percentage, whereas the void volume (gms/gm) is simply the weight increase ratio; that is, PWI divided by 100.

During fabric-creping in a pressure nip, the fiber is preferably redistributed on the fabric, making the process tolerant of less than ideal forming conditions, as are sometimes seen with a Fourdrinier former. The forming section of a Fourdrinier machine includes two major parts, the headbox and the Fourdrinier Table. The latter consists of the wire run over the various drainage-controlling devices. The actual forming occurs along the Fourdrinier Table. The hydrodynamic effects of drainage, oriented shear, and turbulence generated along the table are generally the controlling factors in the forming process. Of course, the headbox also has an important influence in the process, usually on a scale that is much larger than the structural elements of the paper web. Thus the headbox may cause such large-scale effects as variations in distribution of flow rates, velocities, and concentrations across the full width of the machine; vortex streaks generated ahead of and aligned in the machine direction by the accelerating flow in the approach to the slice; and time-varying surges or pulsations of flow to the headbox. The existence of MD-aligned vortices in headbox discharges is common. Fourdrinier formers are further described in The Sheet Forming Process, Parker, J. D., Ed., TAPPI Press (1972, reissued 1994) Atlanta, Ga.

According to the present invention, an absorbent paper web is made by dispersing papermaking fibers into aqueous furnish (slurry) and depositing the aqueous furnish onto the forming wire of a papermaking machine, by way of a jet issuing from the headbox. Any suitable forming scheme might be used. For example, an extensive but non-exhaustive list in addition to Fourdrinier formers includes a crescent former, a C-wrap twin wire former, an S-wrap twin wire former, or a suction breast roll former. The forming fabric can be any suitable foraminous member including single layer fabrics, double layer fabrics, triple layer fabrics, photopolymer fabrics, and the like. Non-exhaustive background art in the forming fabric area includes U.S. Pat. Nos. 4,157,276; 4,605,585; 4,161,195; 3,545,705; 3,549,742; 3,858,623; 4,041,989; 4,071,050; 4,112,982; 4,149,571; 4,182,381; 4,184,519; 4,314,589; 4,359,069; 4,376,455; 4,379,735; 4,453,573; 4,564,052; 4,592,395; 4,611,639; 4,640,741; 4,709,732; 4,759,391; 4,759,976; 4,942,077; 4,967,085; 4,998,568; 5,016,678; 5,054,525; 5,066,532; 5,098,519; 5,103,874; 5,114,777; 5,167,261; 5,199,261; 5,199,467; 5,211,815; 5,219,004; 5,245,025; 5,277,761; 5,328,565; and 5,379,808 all of which are incorporated herein by reference in their entirety. One forming fabric particularly useful with the present invention is Voith Fabrics Forming Fabric 2164 made by Voith Fabrics Corporation, Shreveport, La.

The furnish may contain chemical additives to alter the physical properties of the paper produced. These chemistries are well understood by the skilled artisan and may be used in any known combination. Such additives may be strength aids, latexes, opacifiers, optical brighteners, dyes, pigments, sizing agents, barrier chemicals, retention aids, insolubilizers, organic or inorganic crosslinkers, or combinations thereof; said chemicals optionally comprising polyols, starches, PPG esters, PEG esters, phospholipids, surfactants, polyamines, HMCP (Hydrophobically Modified Cationic Polymers), HMAP (Hydrophobically Modified Anionic Polymers) or the like.

The nascent web is typically dewatered on a papermaking felt. Any suitable felt may be used. For example, felts can have double-layer base weaves, triple-layer base weaves, or laminated base weaves. Preferred felts are those having the laminated base weave design. A wet-press-felt which may be particularly useful with the present invention is Vector 3 made by Voith Fabric. Background art in the press felt area includes U.S. Pat. Nos. 5,657,797; 5,368,696; 4,973,512; 5,023,132; 5,225,269; 5,182,164; 5,372,876; and 5,618,612. A differential pressing felt as is disclosed in U.S. Pat. No. 4,533,437 to Curran et al. may likewise be utilized.

Suitable creping fabrics include single layer, multi-layer, or composite preferably open meshed structures. Fabrics may have at least one of the following characteristics: (1) on the side of the creping fabric that is in contact with the wet web (the “top” side), the number of machine direction (MD) strands per inch (mesh) is from 10 to 200 and the number of cross-direction (CD) strands per inch (count) is also from 10 to 200; (2) The strand diameter is typically smaller than 0.050 inch; (3) on the top side, the distance between the highest point of the MD knuckles and the highest point on the CD knuckles is from about 0.001 to about 0.02 or 0.03 inch; (4) In between these two levels there can be knuckles formed either by MD or CD strands that give the topography a three dimensional hill/valley appearance which is imparted to the sheet; (5) The fabric may be oriented in any suitable way so as to achieve the desired effect on processing and on properties in the product; the long warp knuckles may be on the top side to increase MD ridges in the product, or the long shute knuckles may be on the top side if more CD ridges are desired to influence creping characteristics as the web is transferred from the transfer cylinder to the creping fabric; and (6) the fabric may be made to show certain geometric patterns that are pleasing to the eye, which is typically repeated between every two to 50 warp yarns. Suitable commercially available coarse fabrics include a number of fabrics made by Voith Fabrics.

The creping fabric may thus be of the class described in U.S. Pat. No. 5,607,551 to Farrington et al, Cols. 7-8 thereof, as well as the fabrics described in U.S. Pat. No. 4,239,065 to Trokhan and U.S. Pat. No. 3,974,025 to Ayers which patents are incorporated herein by reference. Such fabrics may have about 20 to about 60 filaments per inch and are formed from monofilament polymeric fibers having diameters typically ranging from about 0.008 to about 0.025 inches. Both warp and weft monofilaments may, but need not necessarily be of the same diameter.

In some cases the filaments are so woven and complimentarily serpentinely configured in at least the Z-direction (the thickness of the fabric) to provide a first grouping or array of coplanar top-surface-plane crossovers of both sets of filaments; and a predetermined second grouping or array of sub-top-surface crossovers. The arrays are interspersed so that portions of the top-surface-plane crossovers define an array of wicker-basket-like cavities in the top surface of the fabric which cavities are disposed in staggered relation in both the machine direction (MD) and the cross-machine direction (CD), and so that each cavity spans at least one sub-top-surface crossover. The cavities are discretely perimetrically enclosed in the plan view by a picket-like-lineament comprising portions of a plurality of the top-surface plane crossovers. The loop of fabric may comprise heat set monofilaments of thermoplastic material; the top surfaces of the coplanar top-surface-plane crossovers may be monoplanar flat surfaces. Specific embodiments of the invention include satin weaves as well as hybrid weaves of three or greater sheds, and mesh counts of from about 10×10 to about 120×120 filaments per inch (4×4 to about 47×47 per centimeter), although the preferred range of mesh counts is from about 18 by 16 to about 55 by 48 filaments per inch (9×8 to about 22×19 per centimeter).

Instead of an impression fabric, a dryer fabric may be used as the creping fabric if so desired. Suitable fabrics are described in U.S. Pat. No. 5,449,026 (woven style) and U.S. Pat. No. 5,690,149 (stacked MD tape yarn style) to Lee as well as U.S. Pat. No. 4,490,925 to Smith (spiral style) which patents are incorporated herein by reference.

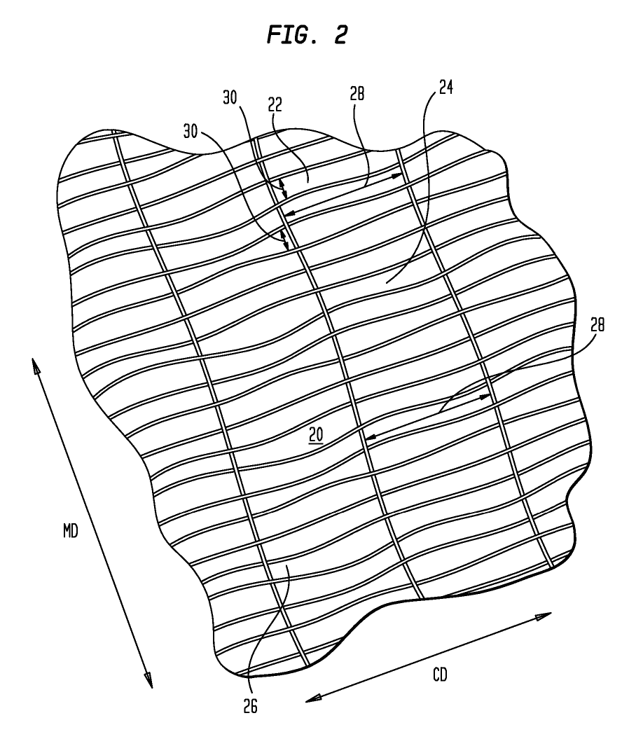

In order to provide a large amount of CD strength, it is preferred to employ creping fabrics with texture cells with relatively large CD/MD aspect ratios as is seen in FIG. 2.

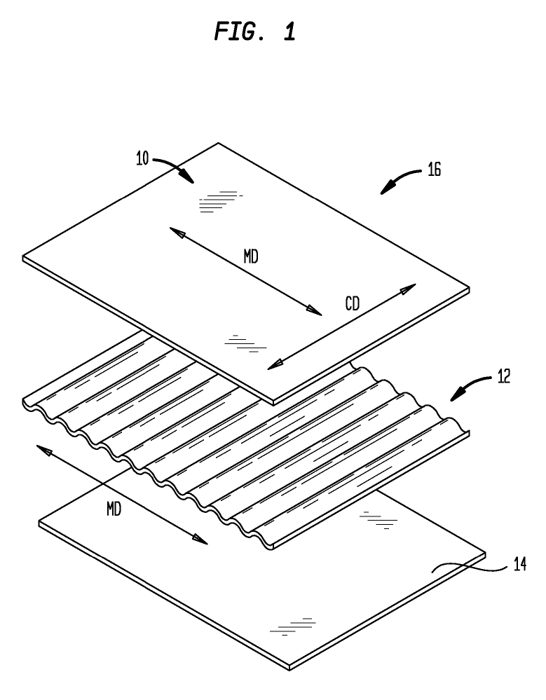

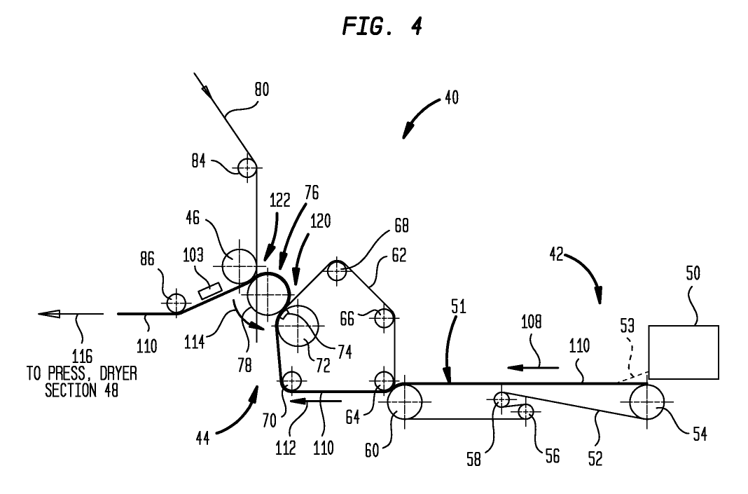

There is shown schematically in FIG. 2 a creping fabric 20 with a plurality of texture cells, such as cells 22, 24, 26. Fabric 20 is oriented in a papermachine such as papermachine 40 of FIG. 4 with the cells elongate in the CD as shown. Each of the cells may have a CD/MD aspect ratio, i.e., the ratio of CD length 28 to MD length 30, of more than about 10, for example. It is believed that when fiber in the web is redistributed by these cells upon fabric-creping that the CD fiber bias acts much like additional corrugation when aligned with the flutes of a corrugated layer of the boxboard. In other words, the elongate CD structures of the linerboard reinforce the flutes of the corrugated layer to provide additional crush resistance when the various layers are plied as is shown in FIG. 1.

Preferably, the texture cells of the web define a texture volume that is anywhere from about 25 percent to about 100 percent of the volume of the web creped from the transfer cylinder. Texture volume/web volume is determined by comparing the surface cavities (i.e., valleys defined the fabric) to the web volume. A web having a caliper of 5 mils has a web volume 0.005 in³ per square inch of web material. A creping fabric defining 0.0025 in³ of texture per square inch has a texture volume of 50 percent with respect to the web.

The creping fabric may have valleys or CD grooves which extend entirely across the CD dimension of the web if so desired.

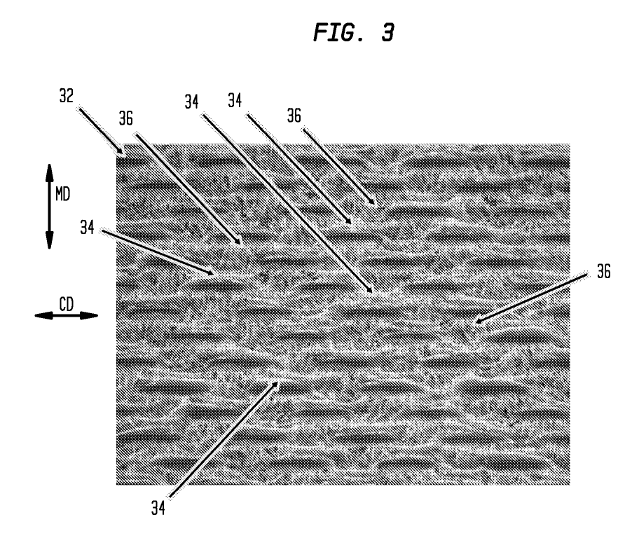

When the web is creped, it has the redistributed structure shown in FIG. 3. FIG. 3 is a photomicrograph (10×) of the fabric side of a fabric-creped web wherein it is seen that sheet 32 has a plurality of very pronounced high basis weight, fiber-enriched regions 34 having fiber with orientation biased in the cross-machine direction (CD) linked by relatively low basis weight regions 36. It is appreciated from the photographs that linking regions 36 have fiber orientation bias extending along a direction between fiber-enriched regions 34. Moreover, it is seen that the enriched elongate regions 34 extend in the CD. CD fiber bias may be visually observable or may be evidenced by reduced MD/CD tensiles as is seen in the various Figures annexed to this description. Further details are also seen in the following co-pending applications: U.S. patent application Ser. No. 11/151,761, filed Jun. 14, 2005, entitled “High Solids Fabric Crepe Process for Producing Absorbent Sheet with In-Fabric Drying” (Attorney Docket 12633; GP-03-35); U.S. Patent application Ser. No. 11/402,609, filed Apr. 12, 2006, entitled “Multi-Ply Paper Towel With Absorbent Core” (Attorney Docket No. 12601; GP-04-11); U.S. Patent application Ser. No. 11/451,112, filed Jun. 12, 2006, entitled “Fabric-Creped Sheet for Dispensers” (Attorney Docket No. 20195; GP-06-12); U.S. Provisional patent application Ser. No. 60/808,863, filed May 26, 2006, entitled “Fabric Creped Absorbent Sheet with Variable Local Basis Weight” (Attorney Docket No. 20179; GP-06-11); and U.S. application Ser. No. 10/679,862, filed Oct. 6, 2003, entitled “Fabric Crepe Process for Making Absorbent Sheet” (Attorney Docket. 12389; GP-02-12) which applications, incorporated herein by reference, disclose particular papermachine details as well as creping techniques, equipment and properties; U.S. application Ser. No. 11/108,375, filed Apr. 18, 2005, entitled “Fabric Crepe/Draw Process for Producing Absorbent Sheet” (Attorney Docket No. 12389P1; GP-02-12-1) also incorporated herein by reference, provides still further processing and composition information; U.S. application Ser. No. 11/108,458, filed Apr. 18, 2005, entitled “Fabric Crepe and In Fabric Drying Process for Producing Absorbent Sheet” (Attorney Docket 12611P1; GP-03-33-1) and U.S. application Ser. No. 11/104,014, filed Apr. 12, 2005, entitled “Wet-Pressed Tissue and Towel Products With Elevated CD Stretch and Low Tensile Ratios Made With a High Solids Fabric Crepe Process” (Attorney Docket 12636; GP-04-5) both of which are incorporated herein by reference, provide some further variation as to selection of components and processing techniques. Another copending application, U.S. Ser. No. 11/451,111, filed Jun. 12, 2006, entitled “Method of Making Fabric Creped Sheet for Dispensers” (Attorney Docket No. 20079; GP-05-10), incorporated herein by reference, provides information on suitable drying and other manufacturing techniques.

After fabric-creping, the web is wet-pressed and densified to a suitable density for linerboard. After wet-pressing, the fiber-enriched areas may be visually less pronounced.

If a Fourdrinier former or other gap former is used as is shown in FIG. 4, the nascent web may be conditioned with vacuum boxes and a steam shroud until it reaches a solids content suitable for transferring to a dewatering felt. The nascent web may be transferred with vacuum assistance to the felt. In a crescent former, use of vacuum assist is unnecessary as the nascent web is formed between the forming fabric and the felt.

One preferred way of drying includes can-drying the web, optionally while it is in contact with the creping fabric. Can drying can be used alone or in combination with impingement air drying, the combination being especially convenient if a two tier drying section layout is available. Suitable rotary impingement air drying equipment is described in U.S. Pat. No. 6,432,267 to Watson and U.S. Pat. No. 6,447,640 to Watson et al., the disclosures of which are incorporated herein by reference. Inasmuch as the process of the invention can readily be practiced on existing equipment with reasonable modifications, any existing flat dryers can be advantageously employed so as to conserve capital as well.

The desired redistribution of fiber is achieved by an appropriate selection of consistency, fabric or fabric pattern, nip parameters, and velocity delta, the difference in speed between the transfer surface and creping fabric. Velocity deltas of at least 100 fpm, 200 fpm, 500 fpm, 1000 fpm, 1500 fpm or even in excess of 2000 fpm may be needed under some conditions to achieve the desired redistribution of fiber and combination of properties as will become apparent from the discussion which follows. In many cases, velocity deltas of from about 500 fpm to about 2000 fpm will suffice. Forming of the nascent web, for example, control of a headbox jet and forming wire or fabric speed is likewise important in order to achieve the desired properties of the product, especially MD/CD tensile ratio. The following salient parameters are selected or controlled in order to achieve a desired set of characteristics in the product: consistency at a particular point in the process (especially at fabric crepe); fabric pattern; fabric-creping nip parameters; fabric crepe ratio; velocity deltas, especially transfer surface/creping fabric and headbox jet/forming wire; and post fabric-crepe handling of the web, especially wet-pressing to densify the web.

Referring to FIG. 4, there is shown schematically a papermachine 40 which may be used to practice the present invention. Papermachine 40 includes a forming section 42, a press section 44, a creping roll 46 wherein the web is creped from a transfer roll 76, as well as we pressing and drying section indicated at 48. Forming section 42 includes: a headbox 50, a forming fabric or wire 52, which is supported on a plurality of rolls to provide a forming table 51. There is thus provided forming roll 54, support rolls 56, 58 as well as a roll 60.

Headbox 50 supplies papermaking furnish to wire 52 in the form of a jet 53 traveling in the same direction as the wire. Control of the speed of the jet and wire is important in achieving the desired product attributes as will be appreciated form the discussion which follows.

Press section 44 includes a paper making felt 62 supported on rollers 64, 66, 68, 70 and shoe press roll 72. Shoe press roll 72 includes a shoe 74 for pressing the web against transfer drum or roll 76. Transfer roll or drum 76 may be heated if so desired. Roll 76 includes a transfer surface 78 upon which the web is deposited during manufacture. Crepe roll 46 supports, in part, an impression fabric 80 which is also supported on a plurality of roll, such as rolls 84 and 86.

Press and dryer section 48 typically includes a plurality of wet-pressing sections much the same as section 44 to densify the web as well as can dryers, impingement-air dryers and the like. Optionally included are soft, hot calendar rolls for calendering the sheet as noted in U.S. Pat. No. 6,190,500 to Mohan et al., the disclosure of which is incorporated herein in its entirety by reference thereto. While any suitable pressure may be used to wet press or calendar the linerboard layer of the present invention, it is believed that pressures of up to 10,000 pli or more may be employed to densify the web.

Papermachine 40 is operated such that the web travels in the machine direction indicated by arrows 108, 112, 114 and 116 as is seen in FIG. 4. A paper making furnish at low consistency, generally less than 0.5%, typically about 0.2% or less, is deposited on fabric or wire 52 in the form of a jet 53 to form a web 110 on table 51 as is shown in the diagram. Web 110 is conveyed in the machine direction to press section 44 and transferred onto a press felt 62 as is seen in FIG. 4. In this connection, the web is typically dewatered to a consistency of between about 10 and 15 percent on wire 52 before being transferred to the felt. So also, roll 64 may be a vacuum roll to assist in transfer to the felt 62. On felt 62, web 110 is dewatered to a consistency typically of from about 20 to about 25 percent prior to entering a press nip indicated at 120. At nip 120 the web is pressed onto cylinder 76 by way of shoe press roll 72. In this connection, the shoe 74 exerts pressure where upon the web is transferred to surface 78 of roll 76 at a consistency of from about 15 to 75 percent on the transfer roll. Transfer roll 76 translates in the machine direction indicated by 114 at a first speed.

Creping fabric 80 travels in the direction indicated by arrow 116 and picks up web 110 in the creping nip indicated at 122. Fabric 80 is traveling at second speed slower than the first speed of the transfer surface 78 of roll 76. Thus, the web is provided with a fabric crepe typically in an amount of from about 10 to about 300 percent in the machine direction.

The creping fabric defines a creping nip over the distance in which creping fabric 80 is adapted to contact surface 78 of roll 76; that is, applies significant pressure to the web against the transfer cylinder. To this end, backing (or creping) roll 46 may be provided with a soft deformable surface which will increase the length of the creping nip and increase the fabric-creping angle between the fabric and the sheet and the point of contact or a shoe press roll could be used as roll 46 to increase effective contact with the web in high impact fabric-creping nip 122 where web 110 is transferred to fabric 80 and advanced in the machine direction. By using different equipment at the creping nip, it is possible to adjust the fabric-creping angle or the takeaway angle from the creping nip. A cover on roll 46 having a Pusey and Jones hardness of from about 25 to about 90 may be used. Thus, it is possible to influence the nature and amount of redistribution of fiber, delamination/debonding which may occur at fabric-creping nip 122 by adjusting these nip parameters. In some embodiments it may by desirable to restructure the z-direction interfiber characteristics while in other cases it may be desired to influence properties only in the plane of the web. The creping nip parameters can influence the distribution of fiber in the web in a variety of directions, including inducing changes in the z-direction as well as the MD and CD. In any case, the transfer from the transfer cylinder to the creping fabric is high impact in that the fabric is traveling slower than the web and a significant velocity change occurs. Typically, the web is creped anywhere from 10-60 percent and even higher during transfer from the transfer cylinder to the fabric.

Creping nip 122 generally extends over a fabric-creping nip distance of anywhere from about ⅛″ to about 2″, typically ½″ to 2″. For a creping fabric with 32 CD strands per inch, web 110 thus will encounter anywhere from about 4 to 64 weft filaments in the nip.

The nip pressure in nip 122, that is, the loading between creping roll 46 and transfer roll 76 is suitably 20-200, preferably 40-70 pounds per linear inch (PLI).

Following wet fabric-creping onto fabric 80, the web is wet-pressed and dried in the pressing and drying section 48. If necessary, the creped web is re-wet prior to further wet-pressing to make the pressing more effective.

One method of wet-pressing the fabric-creped web is by way of a controlled pressure, extended nip shoe press, shown, for example, in U.S. Pat. No. 6,036,820 of Schiel et al., the disclosure of which is incorporated herein by reference. However, any suitable press, typically with a press blanket and at least one dewatering felt can be used.

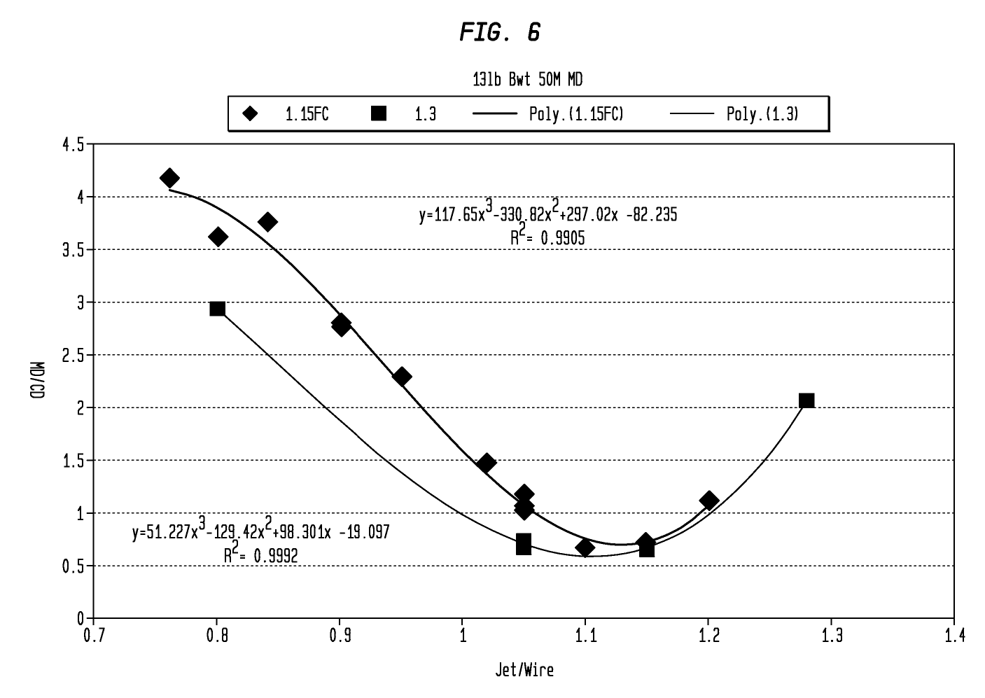

FIGS. 5 and 6 are plots of MD/CD tensile ratios for various cellulosic webs. Here it is seen that the lowest MD/CD ratios (height relative CD strength) occurs at jet/wire speeds slightly greater than 1.

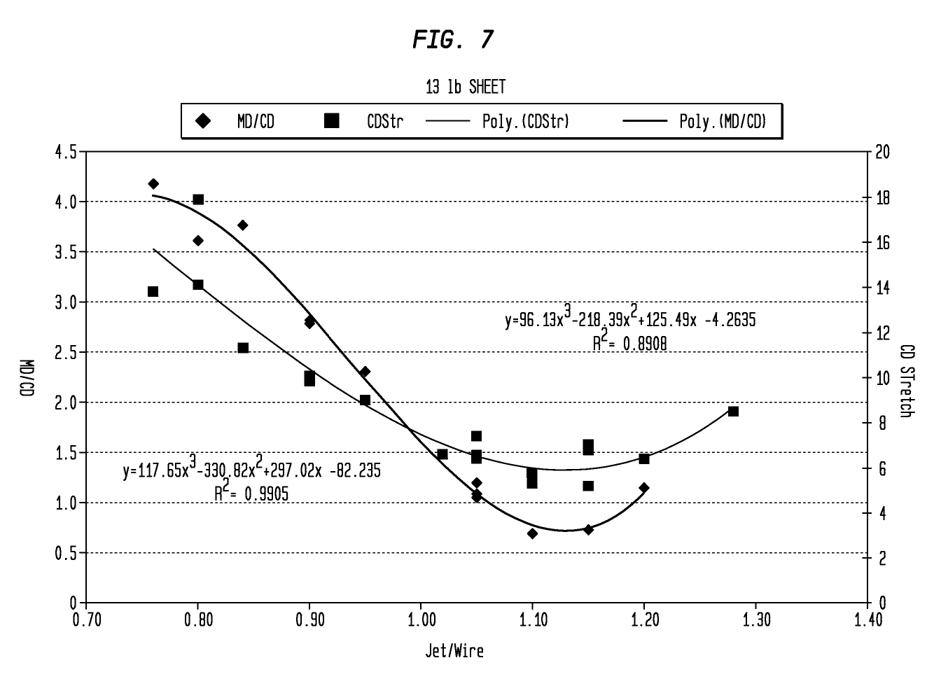

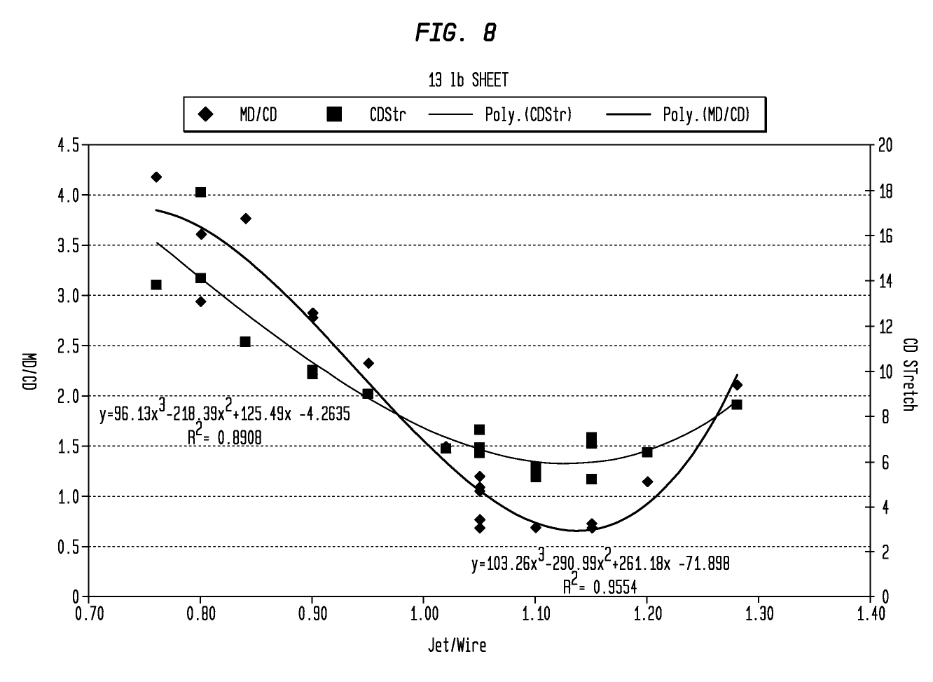

FIGS. 7 and 8 are plots similar to FIGS. 5 and 6 including an additional curve showing CD stretch versus jet/wire velocity ratio. Here it is seen that both the MD/CD and CD stretch values for the web are lowest and jet/wire velocity ratios slightly greater than 1.

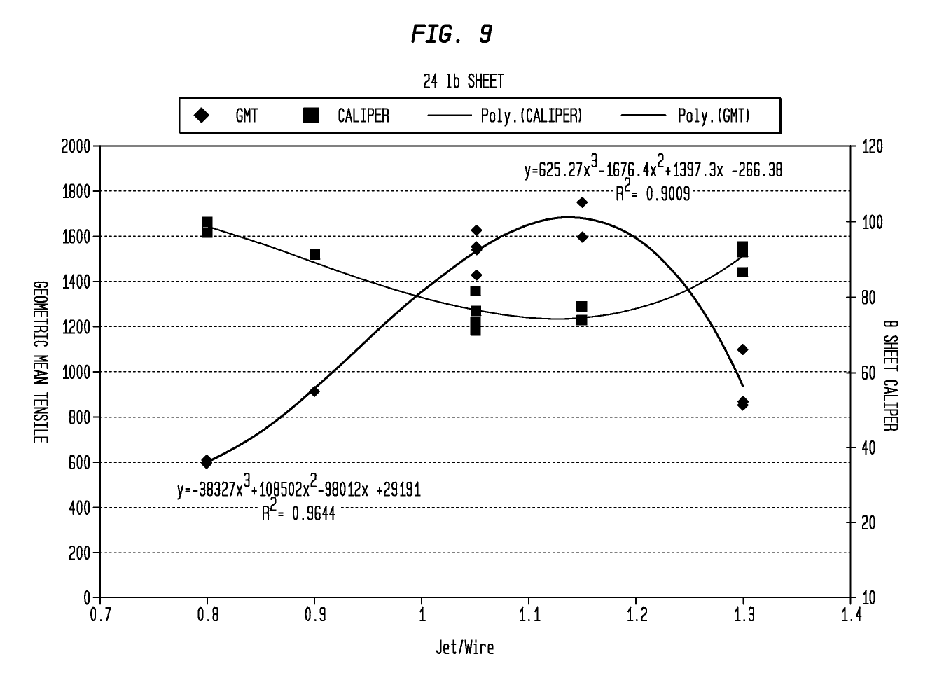

FIG. 9 is a plot of GMT versus jet/wire velocity ratio and caliper versus jet/wire ratio for as-creped 24 lb material. Here it is seen that GMT is at a maximum at jet/wire velocity ratios between about 1.1 and 1.2. Moreover, caliper is lowest at similar jet/wire velocity ratios.

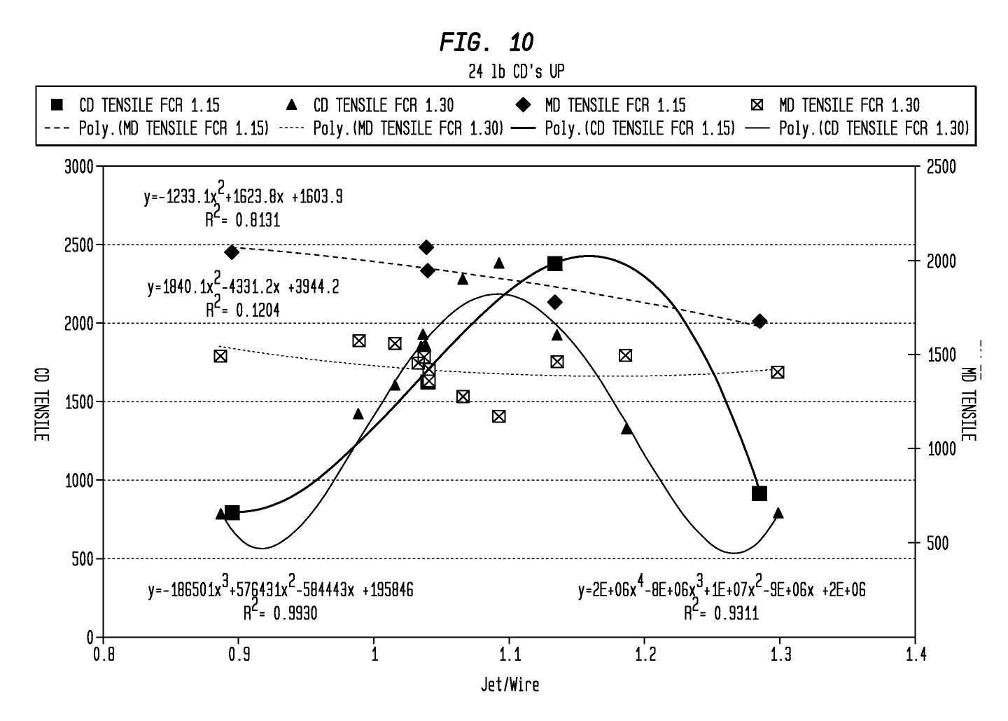

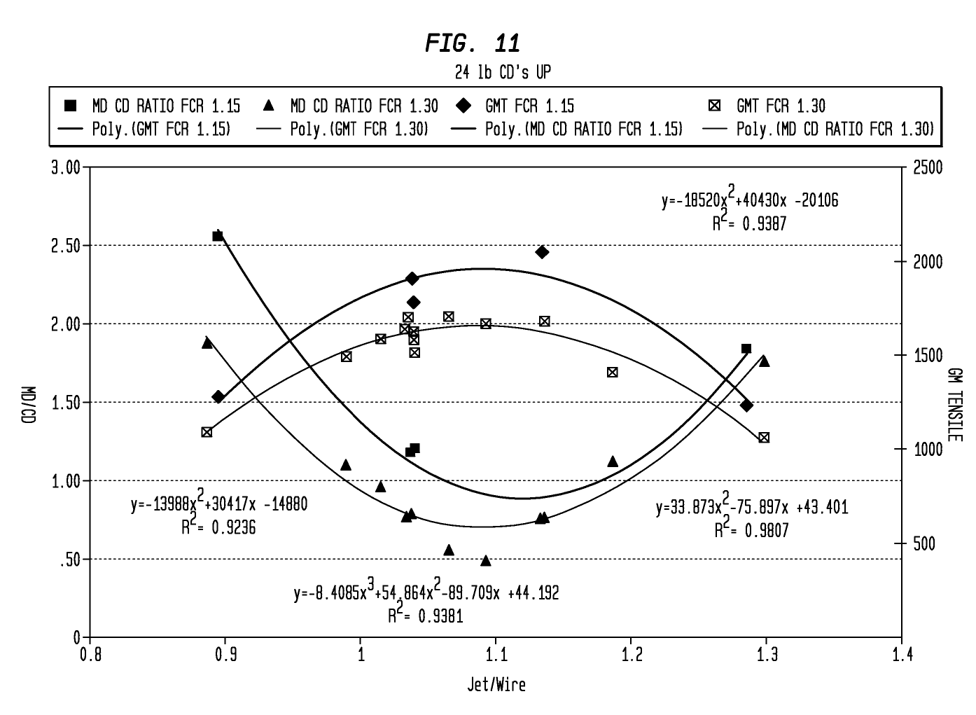

FIG. 10 is a plot of CD tensile ratio and MD tensile ratio versus jet/wire velocity ratio. Here it is seen that MD tensile remains relatively constant, while CD tensile can be varied immensely. This is indeed a surprising result in that in conventional processes the opposite behavior is observed—MD tensile is more variable than CD tensile depending on manufacturing conditions. From FIG. 10 it will be appreciated that the CD strength of the web is optimized when GMT is at a maximum because MD tensile remains relatively constant. In FIG. 11 GMT and MD/CD tensile ratio are plotted against jet/wire velocity ratio and it is seen GMT is maximized and MD/CD tensile ratio is minimized at a ratio of about 1.1.

The present invention was further demonstrated by preparing paperweb samples using a handsheet apparatus, some of which were fabric-creped in accordance with the invention. Creped and uncreped samples were also wet pressed at 50 psi for 5½ minutes and compared with an unpressed web. Details as to the product and properties appear in Table 1.

TABLE 1
Web Properties

| | Basis | | | | | Taber | Taber | | | | | | | Wet Tens | Wet Tens |
|---|---|---|---|---|---|---|---|---|---|---|---|---|---|---|---|
| | Weight | Basis | Caliper | Mullen | ZDT | Stiff- | Stiff- | | | | | TEA | TEA | Finch | Finch |
| | lb/ | Weight | 1 Sheet | Burst | Fiber | ness | ness | Tensile | Tensile | | | MD | CD | Cured- | Cured- |
| | 1000 ft² | Raw | mils/ | Dry | Bond | MD | CD | MD | CD | Stretch | Stretch | in-lb/ | in-lb/ | MD | CD |
| Description | Appx. | Wt g | 1 sht | psi | psi | g cm | g cm | lb/l in | lb/l in | MD % | CD % | in\hat{ }2 | in\hat{ }2 | g/3 in. | g/3 in. |
| Control | 22 | 0.282 | 12.988 | 15.0 | 14.4 | 5.9 | 5.9 | 7.827 | 7.8 | 1.96 | 1.96 | 0.151 | 0.151 | 1,281.89 | 1,281.89 |
| Pressed | 20 | 0.260 | 7.358 | 24.5 | 40.7 | 2.8 | 2.8 | 13.659 | 13.7 | 2.92 | 2.92 | 0.326 | 0.326 | 1,710.21 | 1,710.21 |
| Creped - | 24 | 0.313 | 17.830 | 15.1 | 11.1 | 1.7 | 4.8 | 4.652 | 7.259 | 8.67 | 1.72 | 0.266 | 0.123 | 914.16 | 1,216.80 |
| MD/CD | | | | | | | | | | | | | | | |
| Creped/ | 23 | 0.301 | 8.882 | 22.4 | 38.5 | 2.1 | 3.8 | 9.737 | 11.782 | 6.76 | 2.35 | 0.449 | 0.238 | 1,486.79 | 1,793.83 |
| Pressed - | | | | | | | | | | | | | | | |
| MD/CD | | | | | | | | | | | | | | | |

Pressed 50 psi for 5½ minutes.
Fabric 259-15

It will be appreciated from Table 1 that pressing the webs reduced caliper while increasing the Mullen burst strength and the ZDT fiber bonding values. The creped product (unpressed and pressed) had MD/CD tensile ratios which were quite low, less than 1, indicating a CD strength bias.

Another advantage of the present invention is that the caliper of the board remains relatively high with respect to uncreped board. It will be appreciated by one of the skill in the art that stiffness is a strong function of caliper; typically stiffness is proportional to caliper to the third power. For most of its uses, the economic value of linerboard depends upon its stiffness and crush strength. It will be appreciated from the foregoing that the CD fiber bias in the board increases its utility and value without using more fiber. These properties are perhaps still further appreciated by reference to TAPPI Test Method T 489 om-99 (Taber Stiffness) and TAPPI Test Method T 822 om -02 (Ring Crush).

Other physical properties of linerboard, particularly surface smoothness, appearance and coefficient of friction of the outer surface, are important properties of the product. Low coefficients of friction are undesirable in many cases because low friction surfaces will have a reduced slide angle. Slide angles of about 20 degrees or more are required in many cases. An advantage of the present invention is that the CD strength due to fiber rearrangement can be imparted to a particular embodiment as is needed for the application, while making it possible to maintain desired smoothness (or roughness) of the linerboard. For example, if a single ply linerboard construction is employed, only a portion of the fiber in a particular ply might be rearranged in order to provide CD strength while not affecting the opposite surface of the linerboard. Such constructions may be achieved by any number of ways, for example, one could use a relatively slow moving, dandy roll to crepe a portion of the web in order to impart CD fiber bias to a portion of the fiber in a moving web while leaving the fiber distal to the dandy roll relatively undisturbed; or, one might employ a relatively shallow creping fabric.

Alternatively, a multi-ply type construction discussed in the aforementioned U.S. Pat. No. 6,190,500 to Mohan et al. could be used to make the linerboard wherein one layer is creped to impart CD bias to an inner ply of the linerboard whereas an outer ply of the same linerboard is relatively undisturbed or has at least one undisturbed surface.

While the invention has been described in connection with numerous examples, modifications to those examples within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary.

What is claimed is:

1. A method of making linerboard with elevated CD strength comprising:
a) compactively dewatering a papermaking furnish to form a nascent web having an apparently random distribution of papermaking fibers;
b) applying the dewatered web having apparently random fiber distribution to a translating transfer surface moving at a first speed;
c) fabric-creping the web from the transfer surface at a consistency of from about 15 to about 75 percent utilizing a patterned creping fabric, the creping step occurring under pressure in a fabric-creping nip defined between the transfer surface and the creping fabric, wherein the fabric is traveling at second speed slower than the speed of said transfer surface, the fabric pattern, nip parameters, velocity, delta and web consistency being selected such that the web is creped from the transfer surface and distributed on the creping fabric to form a fabric-creped web with a relative CD strength bias;
d) wet-pressing the web after fabric-creping; and
e) drying the web.

2. The method of making linerboard according to claim 1, further comprising re-wetting the web after fabric-creping and prior to wet-pressing the fabric-creped web.

3. The method of making linerboard according to claim 1, wherein the web is fabric-creped from the transfer surface at a consistency of from about 20 percent to about 60 percent.

4. The method of making linerboard according to claim 1, wherein the web is fabric-creped from the transfer surface at a consistency of from about 30 to about 50 percent.

5. The method of making linerboard according to claim 1, operated at a fabric crepe of from about 10 to about 100 percent.

6. The method of making linerboard according to claim 1, operated at a fabric crepe of at least about 40 percent.

7. The method according to claim 1, operated at a fabric crepe of at least about 60 percent.

8. The method according to claim 1, operated at a fabric crepe of at least about 80 percent.

9. The method of making linerboard according to claim 1, wherein the fabric-creped web is provided with a plurality of elongate regions extending in the CD.

10. The method of making linerboard according to claim 1, wherein fabric-creped web is provided with a plurality of elongate fiber-enriched regions extending in the CD interconnected by lower basis weight linking regions.

11. The method of making linerboard according to claim 1, wherein the creping fabric has a texture volume of from about 25 percent to about 100 percent with respect to the web volume.

12. The method of making linerboard according to claim 1, wherein the creping fabric has a texture volume of from about 35 percent to about 75 percent with respect to the web volume.

13. The method of making linerboard according to claim 1, wherein the creping fabric has texture cells with a CD/MD aspect ratio of at least about 5.

14. The method of making linerboard according to claim 1, wherein the creping fabric has texture cells with a CD/MD aspect ratio of at least about 10.

15. The method of making linerboard according to claim 1, wherein the creping fabric has texture cells with a CD/MD aspect ratio of at least about 25.

16. The method of making linerboard according to claim 1, wherein the creping fabric has texture cells with a CD/MD aspect ratio of at least about 50.

17. The method of making linerboard according to claim 1, wherein the creping fabric has texture cells with CD/MD aspect ratios of 100 or more.

18. The method of making linerboard according to claim 1, wherein the fiber in the papermaking furnish consists essentially of Southern softwood fiber.

19. The method of making linerboard according to claim 1, wherein the papermaking fiber in the furnish consists of Southern softwood fiber.

20. The method of making linerboard according to claim 1, wherein the linerboard has a basis weight of from about 7.5 lbs/1000 sq. ft ream to about 100 lbs/1000 sq. ft. ream.

21. The method of making linerboard according to claim 1, wherein the linerboard has a basis weight of from about 10 lbs/1000 sq. ft. ream to about 60 lbs/1000 sq. ft. ream.

22. The method of making linerboard according to claim 1, wherein the linerboard has a basis weight of from about 15 lbs/1000 sq. ft. ream to about 35 lbs/1000 sq. ft. ream.

23. A method of making linerboard with elevated CD strength comprising:
a) preparing a cellulosic furnish;
b) providing the papermaking furnish to a forming fabric as a jet issuing from a headbox at a jet speed;
c) compactively dewatering the papermaking furnish to form a nascent web having apparently random distribution of papermaking fibers;
d) applying the dewatered web having the apparently random fiber distribution to a translating transfer surface moving at a first speed;
e) fabric-creping the web from a transfer surface at a consistency of from about 15 to about 75 percent utilizing a pattern creping fabric, the creping step occurring under pressure in a fabric-creping nip defined between the transfer surface and the creping fabric wherein the fabric is traveling at a second speed slower than the speed of said transfer surface, the fabric pattern, nip parameters, velocity delta and web consistency being selected such that the web is creped from the transfer surface and distributed on the creping fabric to form a fabric-creped web with a relative CD strength bias;
f) wet-pressing the web after fabric-creping;
g) drying the web;
h) optionally calendering the web; and
i) controlling the jet and forming fabric speed, fabric-creping, wet-pressing and drying steps, as well as selecting a creping fabric and furnish such that the linerboard has a MD/CD tensile ratio of about 2.5 or less.

24. The method according to claim 23, wherein the jet and forming fabric speed, fabric-creping, wet-pressing and drying steps are controlled and the creping fabric and furnish are selected such that the linerboard has a MD/CD tensile ratio of about 2 or less.

25. The method according to claim 23, wherein the jet and forming fabric speed, fabric-creping, wet-pressing and drying steps are controlled and the creping fabric and furnish are selected such that the linerboard has a MD/CD tensile ratio of about 1 or less.

26. The method according to claim 23, wherein the jet and forming fabric speed, fabric-creping, wet-pressing and drying steps are controlled and the creping fabric and furnish are selected such that the linerboard has a CD stretch of about 5 percent or less.

27. The method according to claim 23, wherein the jet and forming fabric speed, fabric-creping, wet-pressing and drying steps are controlled and the creping fabric and furnish are selected such that the linerboard has a CD stretch of about 4 percent or less.

28. The method according to claim 23, wherein the jet and forming fabric speed, fabric-creping, wet-pressing and drying steps are controlled and the creping fabric and furnish are selected such that the linerboard has a CD stretch of about 3 percent or less.

29. The method according to claim 23, wherein the jet and forming fabric speed, fabric-creping, wet-pressing and drying steps are controlled and the creping fabric and furnish are selected such that the linerboard has a void volume of about 2.5 or less.

30. The method according to claim 23, wherein the jet and forming fabric speed, fabric-creping, wet-pressing and drying steps are controlled and the creping fabric and furnish are selected such that the linerboard has a void volume of about 2 or less.

31. The method according to claim 23, wherein the jet and forming fabric speed, fabric-creping, wet-pressing and drying steps are controlled and the creping fabric and furnish are selected such that the linerboard has a void volume between about 1 and about 2.

32. The method of making linerboard according to claim 23, wherein the jet/wire velocity ratio is from about 0.7 to about 1.4.

33. The method of making linerboard according to claim 23, wherein the jet/wire velocity ratio is from about 1 to about 1.3.

34. The method of making linerboard according to claim 23, wherein the jet/wire velocity ratio is from about 1.1 to about 1.25.

35. A method of making multiply linerboard with elevated CD strength comprising:
a) compactively dewatering a papermaking furnish to form a nascent web having an apparently random distribution of papermaking fibers;
b) applying the dewatered web having apparently random fiber distribution to a translating transfer surface moving at a first speed;
c) fabric-creping the web from the transfer surface at a consistency of from about 15 to about 75 percent utilizing a patterned creping fabric, the creping step occurring under pressure in a fabric-creping nip defined between the transfer surface and the creping fabric, wherein the fabric is traveling at second speed slower than the speed of said transfer surface, the fabric pattern, nip parameters, velocity, delta and web consistency being selected such that the web is creped from the transfer surface and redistributed on the creping fabric to form a fabric-creped web with a relative CD strength bias;
d) wet-pressing the web after fabric-creping;
e) plying the fabric-creped web with another ply comprising a web of papermaking fibers; and
f) drying the plied web.

36. The method of making multiply linerboard with elevated CD strength according to claim 35, wherein the fabric-creped layer is wet-pressed after plying.

37. The method of making multiply linerboard with elevated CD strength according to claim 35, wherein the fabric-creped layer is wet-pressed prior to plying.

38. In a method of making linerboard including generally dewatering a papermaking furnish to make a nascent web, as well as wet-pressing and drying the web while the web travels in a machine-direction, the improvement comprising introducing fiber-enriched regions extending in the CD of the web which provide CD strength bias to the web.

39. A linerboard for making combined corrugated boxboard comprising a cellulosic web having a plurality of fiber-enriched elongate regions extending in the CD wherein the web has a MD/CD tensile ratio of about 2.5 or less.

40. The linerboard according to claim 39, wherein the web has a MD/CD tensile ratio of about 2 or less.

41. The linerboard according to claim 39, wherein the web has a MD/CD tensile ratio of about 1 or less.

42. The linerboard according to claim 39, wherein the web has a CD stretch of less than about 5 percent.

43. The linerboard according to claim 39, wherein the web has a CD stretch of less than about 4 percent.

44. The linerboard according to claim 39, wherein the web has a CD stretch of less than about 3 percent.

45. The linerboard according to claim 39, wherein the web has a void volume of less than about 2.5.

46. The linerboard according to claim 39, wherein the web has a void volume of less than about 2.

47. The linerboard according to claim 39, wherein the web has a void volume of between about 1 and about 2.

48. A linerboard for making combined corrugated boxboard, comprising a cellulosic web having a plurality of fiber-enriched elongate regions extending in the CD having CD strength bias as well as a plurality of linking regions of relatively lower basis weights extending between the fiber-enriched regions.

49. Boxboard comprising (i) an outer linerboard layer having a plurality of fiber-enriched, elongated regions extending in the CD of the board, the outer linerboard having an MD/CD tensile ratio of about 2.5 or less; (ii) an inner linerboard layer having a plurality of fiber-enriched, elongate regions extending in the CD of the board, the inner linerboard having an MD/CD tensile ratio of about 2.5 or less; and (iii) a corrugated layer sandwiched between and adhered to the inner and outer linerboard layers, wherein flutes of the corrugated layer are substantially perpendicular to the MDs of the inner and outer linerboard layers.
